(19) United States
(12) Patent Application Publication
(10) Pub. No.: US 2006/0277396 A1
(43) Pub. Date: Dec. 7, 2006

(54) Memory operations in microprocessors with multiple execution modes and register files

(76) Inventors: Erik K. Renno, Trondheim (NO); Oyvind Strom, Trondheim (NO)

Correspondence Address: SCHNECK & SCHNECK, P.O. BOX 2-E, SAN JOSE, CA, 95109-0005, US

(21) Appl. No.: 11/145,770

(22) Filed: Jun. 6, 2005

(51) Int. Cl. G06F 9/44

(52) U.S. Cl. 712/228

(57) ABSTRACT

An apparatus and method for saving and operating on a register set, shadow register file, and memory is presented. A register within a register set that is associated with an active execution state in a computing system is used as an address pointer to a memory location. The content of the memory location is either loaded from memory into an identified shadow register, or the content of a shadow register is stored into the memory location. The operation is normally performed by executing a single instruction by a processor or by circuitry associated with a processor or computer system. Active and inactive execution states may be under the control of an operating system running on the processor or computer system.

### TECHNICAL FIELD

The present invention relates generally to memory operations in microprocessors for both RISC (load store architectures) and CISC (memory array architectures) type computers. Specifically, a method and mechanism for moving the contents of a register file belonging to an execution mode both to and from memory is described.

### BACKGROUND ART

Many modern high-performance microprocessors offer a programming model that supports multiple execution modes or multiple execution states. For example, application programs or software processes running in a multitask operating system environment may run or execute in dedicated execution modes. Different execution modes or execution states may have a variety of different privilege levels.

In a multitask environment, the operating system shares the processor among the various processes which may execute in different execution states. This processor sharing is implemented by switching between processes and execution states. For example, each process is allocated a fixed time period by the operating system, and the operating system then switches to another process or execution state. This switching is also known as context switching.

Each process operates on a fixed set of registers within the processor architecture. Referring to FIG. 1, a processor supporting multiple execution states presents a programming model containing multiple dedicated register banks 110, 120, 130. Each execution mode, x, y, z, may share the same banked register set (or register file). In order to increase the overall performance of the microprocessor system, each execution state may have its own dedicated register set, frequently called banked or shadow registers. Banked or shadow registers remove the need to copy the contents of a particular register set (a register file) to memory when changing from one execution state to another execution state, thereby saving time and increasing the overall performance of the microprocessor system.

A context switch is implemented by swapping out the register contents or register file for the current process or execution state, and swapping in the register file associated with the next process or execution state. A process or execution list is scheduled and the current register file is swapped with a shadow register file when a context switch occurs. The current register file is loaded into the shadow register and the next register file is loaded from a shadow register file into the register set or register structure for the next process or execution state.

A dedicated cache may be used to store a register file. However, the disadvantage of this approach is that extra cache hardware is required. U.S. Patent Application Publication No. 2003/0051124A1 to Dowling entitled “Virtual Shadow Registers and Virtual Register Windows” describes multiple register sets controlled by a dedicated hardware circuit to perform a fast register set save and restore operation. However, additional interface circuitry must be built into the processor core, and an entire register file or register set is selected and switched for each operation.

Typically, when a particular execution mode is running or operating, all of the operations that are performed on the application registers belong to a particular execution state. However, it may be useful to allow certain processes, operations, or other execution states to access or manipulate a register file or selected registers belonging to a particular execution state. Context switch latency affects the execution time of a process because during this process, the processor remains idle. What is needed is an ability to allow one or more execution states to flexibly operate on a register file or operate on selected registers within a register file that belongs to another execution state without requiring a task switch that swaps an entire register file.

### SUMMARY

An exemplary embodiment of the present invention provides at least one additional instruction to a processor's instruction set. The instruction either loads data (content) from memory into a shadow register, or stores data from a shadow register to memory. The instruction may load several shadow registers with content found in a continuous memory space, or store the content from several shadow registers to a contiguous data space.

One advantage of the present invention is an overall speed improvement for task or context switching for multitask operating systems. A microprocessor system is not required to switch execution states or execution modes before copying the contents of a register file to memory. Also, instead of switching tasks, or copying an entire register set, a single instruction may identify a single shadow register or register range associated with an inactive execution state and copy either the content of one or more shadow register to a memory location (or range), or copy a memory location (or range) to one or more shadow register. Additionally, the instruction or method may be used for debugging purposes where the content of one or several register sets or register files may be copied to memory.

### BRIEF DESCRIPTION OF THE DRAWINGS

FIG. 1 is a prior art diagram of banked or shadow registers in a processor supporting multiple execution states.

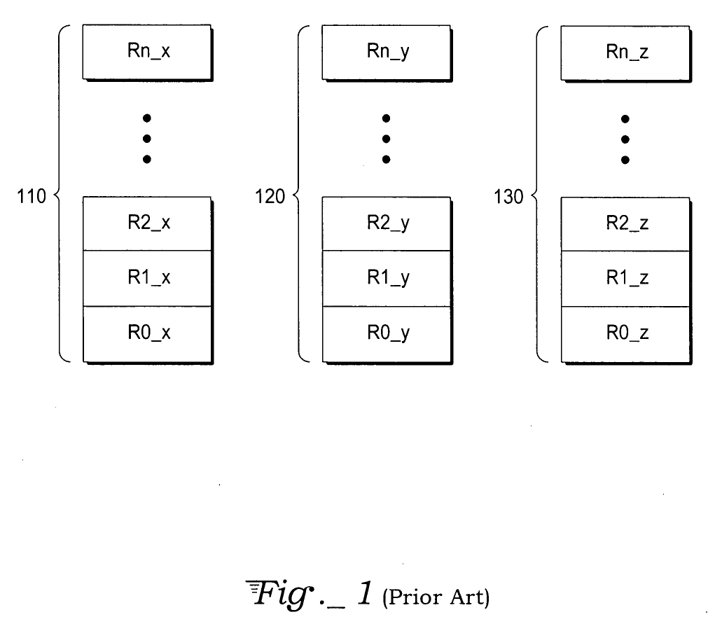

FIG. 2 is a diagram of an exemplary register file implementation having at least one application register set.

FIG. 3A is an architectural diagram of an exemplary register load operation.

FIG. 3B is a flow chart diagram of an exemplary register load operation.

FIG. 4A is an architectural diagram of an exemplary register store operation.

FIG. 4B is a flow chart diagram of an exemplary register store operation.

FIG. 5 is an architectural diagram of an exemplary register load operation loading a content of a range of memory locations into a range of shadow registers.

### DETAILED DESCRIPTION

An exemplary core processor will normally load, decode, and execute instructions. An exemplary processor system or computing system contains the core processor and other functional units such as memory, for example, a RAM or a cache memory. The architecture of the core processor is configured to support shadow registers.

A single instruction, included in a processor's instruction set, loads data (content) related to another execution state from memory into at least one shadow register, or a single instruction stores data (content) related to another execution state from a shadow register to memory. The instruction may load several shadow registers with content found in a continuous memory space, or store the content from several shadow registers to a contiguous data space. The instruction may support an optional parameter that specifies which register bank or shadow register file to load data into (or store data from) or specifies a particular shadow register, multiple shadow registers, or a shadow register range. The instruction may also support an optional parameter specifying the size of the data to be loaded or stored, the size of a register, and whether memory data are a shorter size than the register size, or should be zero or sign extended. The instruction may be optionally restricted to only operate in privileged modes.

Two additional instructions are added to the core processor. Each instruction provides an improved and flexible method or mechanism to speed up the transfer of information between different execution states, for example, execution states that are controlled by an operating system. Also, implementation of each processor instruction minimizes an amount of added circuitry to the processor core in comparison to adding dedicated cache, adding multiple hardware registers, or adding dedicated multiplexer or select circuitry.

A first instruction, executed by an active process or active execution state, loads a content of an identified or designated memory location or multiple memory locations to a shadow register file that corresponds with an inactive execution state. A second instruction, executed by an active process or active execution state, stores a content of an identified or designated shadow register or shadow register range that correspond with another inactive execution state, to an identified or designated memory location or multiple memory locations. Generally, a pointer register, within the register set belonging to the current execution state, is identified. The pointer register contains a memory location where data or content from a designated shadow register will be stored, or where the data or content of the addressed memory will be loaded into a designated shadow register.

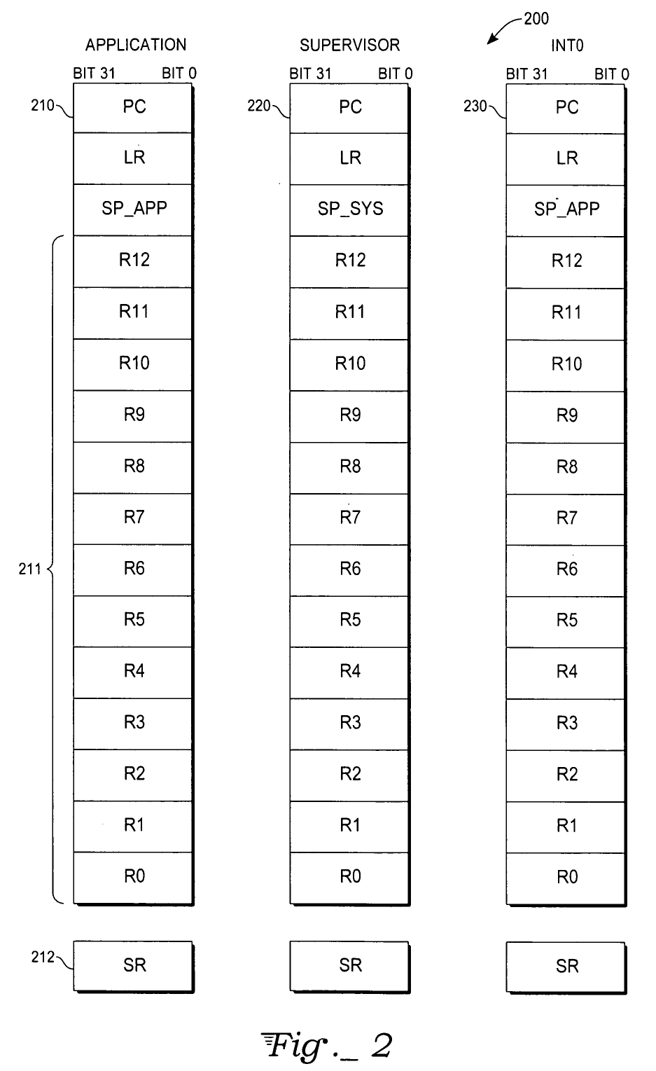

Referring to FIG. 2, an exemplary register architecture 200 having an application register set 210, a supervisor register set 220, and at least one interrupt register set 230 is implemented within the architecture of the core processor. Each register set, for example in the application register set 210, may contain at least one general purpose register (R0-R12) 211 and other registers such as a stack pointer register 212. A stack pointer located in a register file can be used as an ordinary register or to simplify the allocation and access of local variables or other parameters. The stack pointer register 212 may also be used by other instructions supported by the processor. Additional general-purpose (R0-R12) 211, or other dedicated registers, may be designated as a program counter, link register, returned status register, or return address register.

A processor architecture provides shadow registers (not shown in FIG. 2) for at least the application register set 210. The architecture may provide shadow registers for a portion of or all of the register sets. For example, shadow registers may be supported for the interrupt register set 230 and the supervisor register set 220. Register sets may be shadowed using a variety of approaches including using hardware multiplexers, cache memory, or other addressed memory. For example, a register file may be stored in a stack or into another addressed memory area.

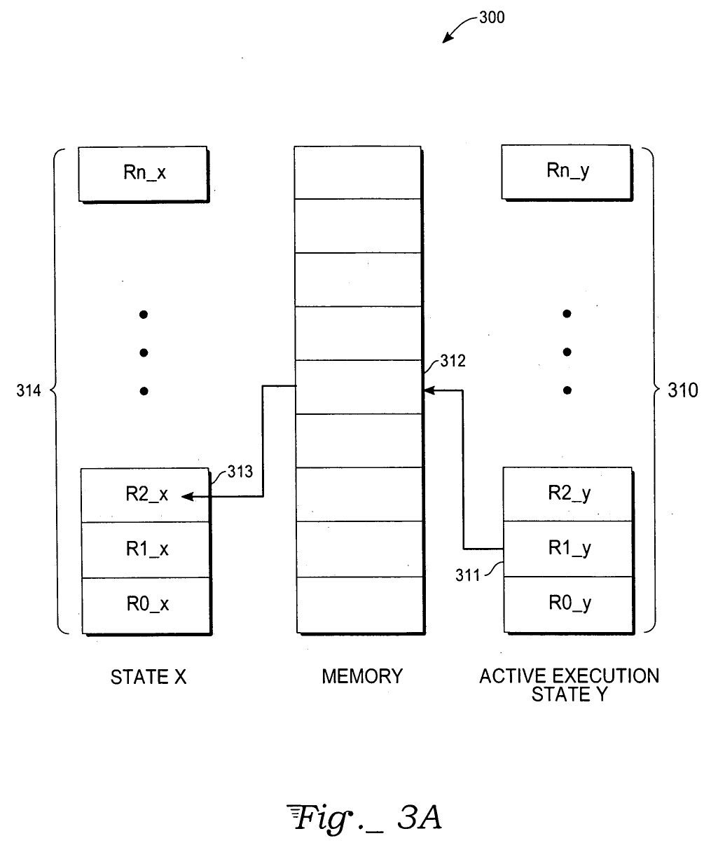

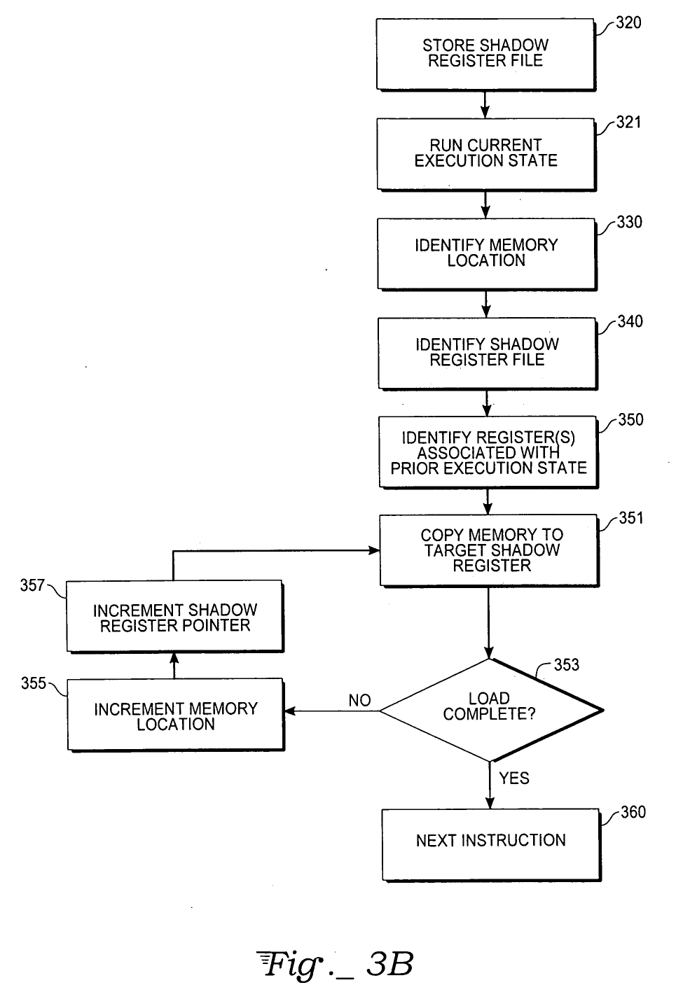

A first exemplary instruction (for example, Load Multiple Registers for Task Switch, or LDMTS) loads the content of a memory location into a specified shadow register file. The register file, for example, may be in a hardware memory accessed by activating a multiplexer or decode circuit, within a memory range in addressed memory, or in a cache memory. Referring to FIG. 3A, in a processor architecture supporting shadow registers 300, a present or active execution state Y, may manipulate a y-register set 310 (R0_y to Rn_y) associated or corresponding with the Y execution state. After an LDMTS instruction has been fetched and decoded by the core processor, the content of a specified y-register 311, for example R1_y, is used as an address pointer to a specific memory address 312. A content of the memory address 312 is then loaded into a specified shadow register 313, for example R2_x, belonging to another (inactive) execution state, for example execution state X. Generally, during the execution of the exemplary LDMTS instruction, the active register 311 (R1_y), inactive execution state (execution state X), and the shadow register 313 belonging to the inactive execution state, are specified. The instruction may manipulate the contents of a single target register, such as R2_x 313, or a range of target registers within the shadow register file 314 (R0_x to Rn_x) of a specific execution state X.

An exemplary first instruction name, syntax, and pseudo code is listed below.

LDMTS—Load Multiple Registers for Task Switch

Description: Loads the consecutive words pointed to by Rp into the registers specified in the instruction. The target registers reside in the Application Register Context, regardless of which context the instruction is called from. If the opcode field [++] is set, an optional write-back of the updated pointer value may be performed.

Operation:

| | |
|---|---|
| I. | Loadaddress [symbol] Rp; |
| | for (i = 15 to 0) |

if Reglist16[i] = = 1 then

RiAPP [symbol] * (Loadaddress+ +);

if Opcode[+ +] = = 1 then

Rp [symbol] Loadaddress;

Syntax:

| | |
|---|---|
| I. | ldmts Rp {+ +}, Reglist16 |

Opcode:

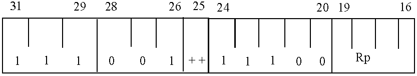

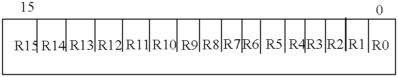

The single load LDMTS instruction loads any consecutive words pointed to by an identified register pointer (Rp), from the register set associated with a current active execution state, into identified shadow registers (Reglist16) associated with an inactive execution state. In one embodiment, the target shadow registers may reside in an Application Register Context that is controlled by an operating system, regardless of which context the LDMTS instruction is called from. In another embodiment, the program counter (PC) may be loaded, resulting in a jump to the loaded value. Also, for example, parameters may be set to perform a variety of alternate operations, for example, if the opcode field [++] (bit 25), is set an optional write-back of an updated pointer value may be performed.

Referring to FIG. 3B, a register set associated with a prior execution state is stored 320 as a shadow register file when a prior execution state becomes inactive. When a current execution state is running 321, a memory location is identified 330. Next, a prior execution state and the associated shadow register file are identified 340. A single register or a register range within the shadow register file associated with the prior execution state is also identified 350. Next, the content of the identified memory location is copied 351 to a target shadow register. A determination 353 is made whether the load operation has been completed. If a single register is to be loaded, the single identified memory location is used. After the single register has been loaded, the load operation is complete and the next instruction is executed 360 by the processor. If multiple registers or a register range is to be loaded, the identified memory location will be used as a starting memory location. After the first register has been loaded, the load operation is not complete. The memory location (address) is incremented 355, and a shadow register pointer is incremented 357. The content of the incremented memory location is then copied 351 to the next shadow register. When the last identified or shadow register has been loaded, the load operation is complete and the next instruction is executed 360 by the processor. In alternate embodiments, memory address pointers and/or shadow register pointers are decremented instead of incremented. Parameters included in the opcode may be used to set or select an increment or decrement.

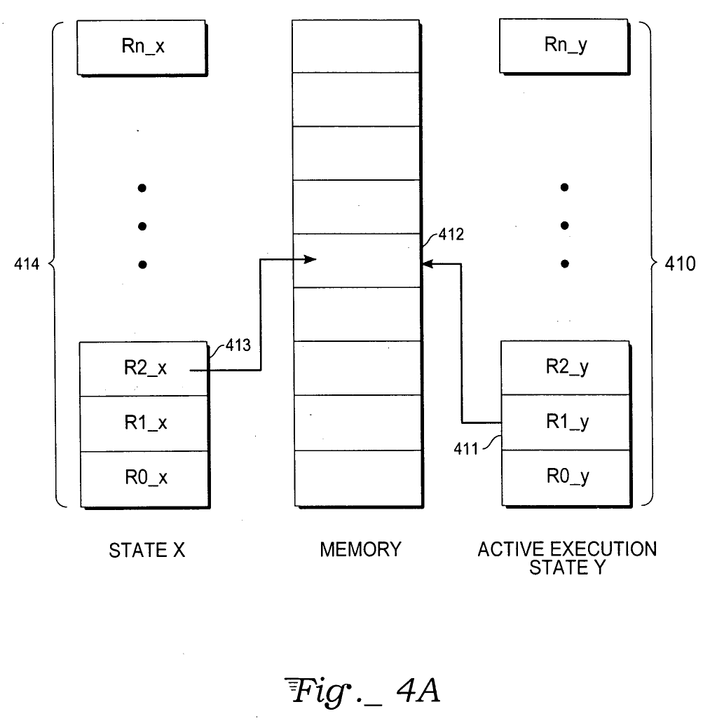

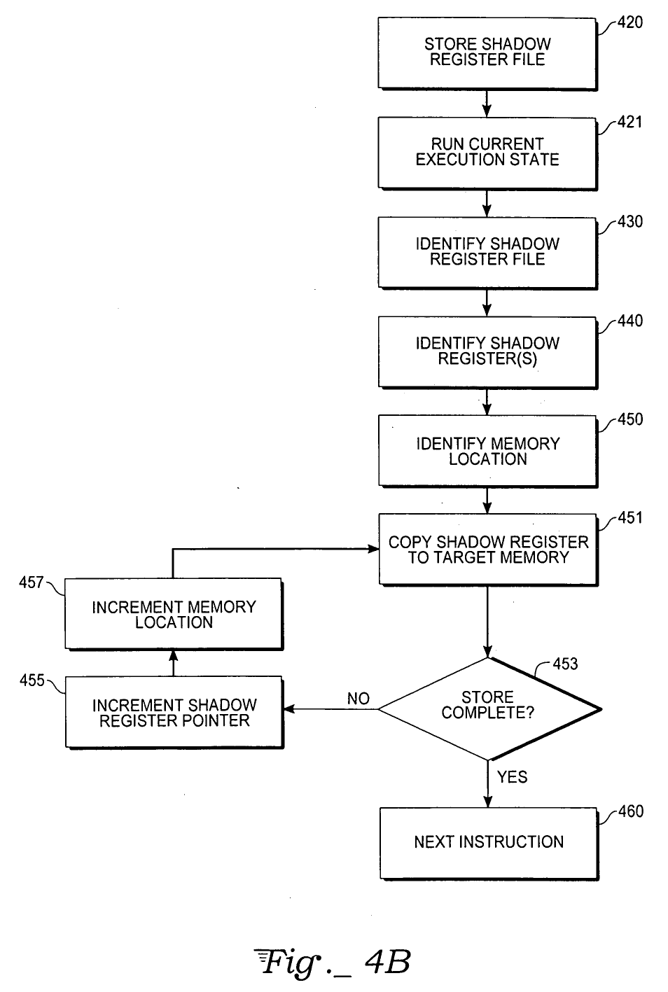

A second exemplary instruction (for example, Store Multiple Registers for Task Switch or STMTS) stores the content of a specified shadow register file into a specified memory location. The register file, for example, may be in a hardware memory accessed by activating a multiplexer or decode circuit, within a memory range in addressed memory, or in a cache memory. Referring to FIG. 4A, in a processor architecture supporting shadow registers, a present or active execution state Y, may manipulate a y-register set 410 (R0_y to Rn_y) associated or corresponding with the Y execution state. After an STMTS instruction has been fetched and decoded by the core processor, the content of a specified y-register 411, for example R1_y, is used as an address pointer to a specific memory address 412. The content of a specified shadow register 413, for example R2_x, belonging to another (inactive) execution state, for example execution state X, is then copied to the memory at the specified address 412. Generally, during the execution of the exemplary STMTS instruction, the active register 411 (R1_y), inactive execution state (execution state X), and the shadow register 413 belonging to the inactive execution state, are specified. The instruction may read the contents of a single source register, such as R2_x 413, or a range of target registers within the shadow register file 414 (R0_x to Rn_x) of a specific execution state (X).

An exemplary second instruction name, syntax, and pseudo code is listed below.

STMTS—Store Multiple Registers for Task Switch

Description: Stores the registers specified to the consecutive memory locations pointed to by Rp. The registers specified reside in the application context. If the opcode field [−−] is set, an optional write back of the updated pointer value may be performed.

Operation:

Storeaddress [symbol] Rp;
if Opcode[− −] = = 1 then

for (i =0 to 15)

if Reglist16[i] = = 1 then

* (− −Storeaddress) [symbol] RiAPP;

Rp [symbol] Storeaddress;

else

for (i = 15 to 0)

if Reglist16[i] = = 1 then

* (Storeaddress+ + [symbol] RiAPP;

Syntax:

| | |
|---|---|
| I. | stmts {− −}Rp, Reglist16 |

Opcode:

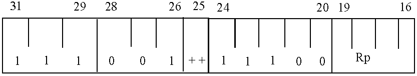

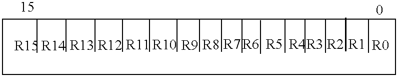

The single store STMTS instruction stores the content of specified consecutive register(s) to consecutive memory locations pointed to by an identified register pointer (Rp), from the register set associated with a current active execution state, into identified shadow registers (Reglist16) associated with an inactive execution state. In one embodiment, all the registers reside in the application context that is controlled by an operating system. In an alternate embodiment, parameters may be set to perform a variety of alternate operations, for example, if the opcode field [−−] (bit 25) is set, a series of store operations are performed while decrementing a memory address pointer, and the memory address pointer may optionally be written back. In another embodiment, when the opcode field [−−] (bit 25) is cleared, the memory address pointer is incremented and no write-back is performed.

Referring to FIG. 4B, a register set associated with a prior execution state is stored 420 as a shadow register file when the prior execution state becomes inactive. When a current execution state is running 421, a prior execution state and the associated shadow register file are identified 430. Next, a single register or a register range within the shadow register file associated with the prior execution state is also identified 440. A memory location is identified 450. Next, the content of the identified shadow register is copied 451 to the target memory location. A determination 453 is made whether the store operation has been completed. If a single register is copied to memory, the single identified memory location is used. After the single register has been copied to memory, the store operation is complete and the next instruction is executed 460 by the processor. If multiple registers or a register range is to be copied to memory, the identified memory location will be used as a starting memory location. After the first register has been copied to memory, the store operation is not complete. The shadow register pointer is incremented 455, and a memory location (address) is incremented 457. In an alternate embodiment, the shadow register pointer may be decremented. For example, the opcode field (Opcode[−−]) 25 may indicate whether a decrement or increment is performed to the shadow register pointer. The content of the next shadow register is then copied 451 to the next memory location. When the last identified or shadow register has been copied 451 to memory, the store operation is complete and the next instruction is executed 460 by the processor.

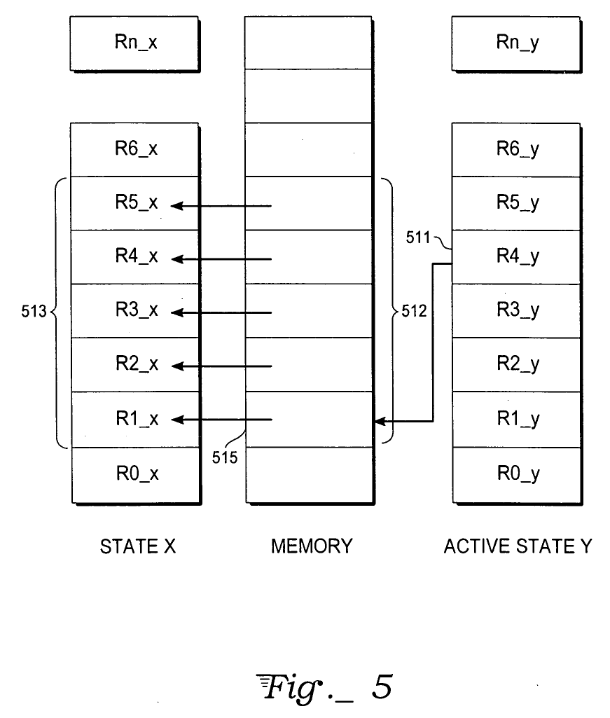

For the load instruction, the content of a memory location range (multiple memory locations) may be read and copied to a shadow register file. For the store instructions, the content of a shadow register file (multiple shadow register content) may be copied to a memory location range. For example, referring to FIG. 5, the content of a specified y-register 511, R4_y in this example, is used as an address pointer to a starting memory address 515. The content of the memory location range 512 is then loaded into a specified a register range 513 within a shadow register file, R1_x-R5_x in this example, belonging to an associated inactive execution state. The store instruction operates in a symmetrical manner. When performing task or context switches for an operating system, the multiple store instruction allows efficient spooling of register contents associated with an inactive task to the operating system stack residing in memory. The register contents of the active task may then be loaded from the stack by executing another multiple load instruction.

Exemplary embodiments of additional instructions to a processor's instruction set that loads data from memory into a shadow register, or that stores data (content) from a shadow register to memory are presented. The instruction may load several shadow registers with content found in a continuous memory space, or store the content from several shadow registers to a contiguous data space. Those of skill in the art will recognize that the invention can be practiced with modification and alteration within the spirit and scope of the appended claims and many other embodiments will be apparent to those of skill in the art upon reading and understanding the description presented herein. For example, alternate op-codes, naming conventions, and syntax may be used. Also, although the operations are performed by a single instruction, the single instruction may be co-executed with other instructions in a pipelined processor system. The instructions may be implemented by or included in the instruction set of RISC, CISC, or other processor types. The number of registers or types of registers may vary. For example, each register file may contain 16 registers (R0-R15) having a program counter (PC) residing in R15. Although shadowing of application registers are described, other register types such as supervisor or interrupt register sets may also be included as targets for the described instructions. In addition, other architectures or processor implementations that support shadow registers may be used. Therefore, the description is to be regarded as illustrative instead of limiting.

What is claimed is:

1. A computing system comprising:
a register set having at least one register, the register set configured to store information associated with an active execution state;
a processor, the processor being electronically coupled to the register set and having:
a first portion of processor logic configured to store data into a shadow register file, the shadow register file having at least one shadow register, the shadow register file configured to save a content of a register set associated with an inactive execution state;
a second portion of processor logic configured to address or select a memory location, the memory location configured to store a content of the at least one shadow register; and
a third portion of processor logic configured to execute a single instruction which identifies a single register in the register set, the third portion of processor logic being further configured to use a content of the single register as a memory address pointer to specify a memory location and copy the content of the specified memory location to at least one shadow register located in the shadow register file.

2. The computing system of claim 1, wherein the single instruction is a part of an instructions set of the processor instruction set.

3. The computing system of claim 1, wherein a portion of processor logic is configured to identify a specific shadow register file from a parameter in the single instruction.

4. The computing system of claim 1, wherein a portion of processor logic is configured to identify a single shadow register from a parameter in the single instruction.

5. The computing system of claim 1, wherein a portion of processor logic is configured to identify multiple shadow registers from a parameter in the single instruction.

6. The computing system of claim 1, wherein a portion of processor logic is configured to identify a range of shadow registers from a parameter in the single instruction.

7. The computing system of claim 1, wherein a portion of processor logic is configured to identify the size of a register from a parameter in the single instruction.

8. A computing system comprising:
a register set having at least one register, the register set configured to store information associated with an active execution state;
processor logic configured to store a shadow register file having at least one shadow register, the shadow register file configured to save the contents of a register set associated with an inactive execution state;
processor logic configured to address or select a memory location, the memory location configured to store the content of the at least one shadow register; and
processor logic configured to execute a single instruction which identifies a single register in the register set and using the content of the single register as a memory address pointer to specify a memory location, and copy the content of at least one shadow register located in the shadow register file to the specified memory location.

9. The processor or computing system of claim 8, wherein the single instruction is part of processor's instruction set.

10. The processor or computing system of claim 8, wherein the processor logic is configured to identify a specific shadow register file from a parameter in the single instruction.

11. The processor or computing system of claim 8, wherein the processor logic is configured to identify a single shadow register from a parameter in the single instruction.

12. The processor or computing system of claim 8, wherein the processor logic is configured to identify multiple shadow registers from a parameter in the single instruction.

13. The processor or computing system of claim 8, wherein the processor logic is configured to identify a range of shadow registers from a parameter in the single instruction.

14. The processor or computing system of claim 8, wherein the processor logic is configured to identify the size of a register from a parameter in the single instruction.

15. A method for performing a shadow register operation in a computer system, the method comprising:
executing a single instruction by:
identifying a specific general-purpose register;
addressing a specific memory location using a content of the specified general-purpose register as the memory location address;
identifying a target shadow register file;
identifying at least one target shadow register in the identified shadow register file; and
copying a content of the specific memory location to the target shadow register in the identified shadow register file.

16. The method for performing a shadow register operation of claim 15, wherein the identified shadow register file is associated with an inactive execution state controlled by an operating system.

17. The method for performing a shadow register operation of claim 15, wherein a parameter in the single instruction is used to identify the target shadow register file.

18. The method for performing a shadow register operation of claim 15, wherein a parameter in the single instruction is used to identify a single target shadow register.

19. The method for performing a shadow register operation of claim 15, wherein a parameter in the single instruction is used to identify multiple target shadow registers.

20. The method for performing a shadow register operation of claim 15, wherein a parameter in the single instruction is used to identify a range of target shadow registers.

21. The method for performing a shadow register operation of claim 15, wherein a parameter in the single instruction is used to identify a size of a register.

22. A method for performing a shadow register operation, the method comprising:
executing a single instruction by:
identifying a specific general-purpose register;
addressing a specific memory location using a content of the specified general-purpose register as the memory location address;
identifying a target shadow register file;
identifying at least one target shadow register in the identified shadow register file; and
copying a content of the target shadow register in the identified shadow register file to the specific memory location.

23. The method for performing a shadow register operation of claim 22, wherein the identified shadow register file is associated with an inactive execution state controlled by an operating system.

24. The method for performing a shadow register operation of claim 23, wherein a parameter in the single instruction is used to identify the target shadow register file.

25. The method for performing a shadow register operation of claim 23, wherein a parameter in the single instruction is used to identify a single target shadow register.

26. The method for performing a shadow register operation of claim 23, wherein a parameter in the single instruction is used to identify multiple target shadow registers.

27. The method for performing a shadow register operation of claim 23, wherein a parameter in the single instruction is used to identify a range of target shadow registers.

28. The method for performing a shadow register operation of claim 23, wherein a parameter in the single instruction is used to identify a size of a register.

29. A processor comprising:
a register set associated with an active execution state;
means for saving a register set content, the register set being associated with an inactive execution state, into a shadow register file, the shadow register file having at least one shadow register;
means for addressing a memory location, the memory location being configured to store a shadow register content of the at least one shadow register; and
means for executing a single instruction, the single instruction identifying a single register in the register set associated with an active execution state, the single instruction using a content of the single register as a memory address pointer to specify a memory location, and the single instruction copying the specified memory location content into a single one of the at least one shadow register located in the shadow register file.

30. The processor of claim 29, wherein the means for saving the contents of a register set is controlled by an operating system.

31. The processor of claim 29, wherein the means for executing a single instruction further comprises selecting a parameter associated with the single instruction to identify the shadow register file.

32. The processor of claim 29, wherein the means for executing a single instruction further comprises selecting a parameter associated with the single instruction to identify a single shadow register.

33. The processor of claim 29, wherein the means for executing a single instruction further comprises selecting a parameter associated with the single instruction to identify multiple target shadow registers.

34. The processor of claim 29, wherein the means for executing a single instruction further comprises selecting a parameter associated with the single instruction to identify a range of target shadow registers.

35. The processor of claim 29, wherein the means for executing a single instruction further comprises selecting a parameter associated with the single instruction to identify the size of the at least one shadow register.

36. A processor comprising:
a register set associated with an active execution state;
means for saving a register set content, the register set being associated with an inactive execution state, from a shadow register file to memory, the shadow register file having at least one shadow register;
means for addressing a memory location, the memory location being configured to store a shadow register content of the at least one shadow register; and
means for executing a single instruction, the single instruction identifying a single register in the register set associated with an active execution state, the single instruction specifying a memory location using a content of the single register associated with an active execution state as a memory address pointer, and the single instruction copying a content of a single one of the at least one shadow register located in the shadow register file into the specified memory location.

37. The processor of claim 36, wherein the means for saving the contents of a register set is controlled by an operating system.

38. The processor of claim 36, wherein the means for executing a single instruction further comprises selecting a parameter associated with the single instruction to identify the shadow register file.

39. The processor of claim 36, wherein the means for executing a single instruction further comprises selecting a parameter associated with the single instruction to identify a single shadow register.

40. The processor of claim 36, wherein the means for executing a single instruction further comprises selecting a parameter associated with the single instruction to identify multiple target shadow registers.

41. The processor of claim 36, wherein the means for executing a single instruction further comprises selecting a parameter associated with the single instruction to identify a range of target shadow registers.

42. The processor of claim 36, wherein the means for executing a single instruction further comprises selecting a parameter associated with the single instruction to identify the size of a register.
